(19) United States
(12) Patent Application Publication
(10) Pub. No.: US 2023/0206719 A1
(43) Pub. Date: Jun. 29, 2023

(54) METHOD, SYSTEM, AND TABLE FOR CONDUCTING A PLAYER-BANKED POKER GAME

(71) Applicant: INNOVATIVE GAMING CONCEPTS LLC, Lake Worth, FL (US)

(72) Inventor: Brian Patrick Birkenmeyer, Lake Worth, FL (US)

(73) Assignee: INNOVATIVE GAMING CONCEPTS LLC, Lake Worth, FL (US)

(21) Appl. No.: 17/926,901

(22) PCT Filed: May 21, 2020
(86) PCT No.: PCT/US2020/034073

§ 371 Date: Nov. 21, 2022

(51) Int. Cl. G07F 17/32

(52) U.S. Cl. CPC G07F 17/322; G07F 17/3209; G07F 17/3211; G07F 17/3258; G07F 17/3269; G07F 17/3276; G07F 17/3293

(57) ABSTRACT

A method of providing a player-banked poker game on a specialized table that includes providing a card playing table with a card playing surface positioned above a support surface and a plurality of buttons positioned around the card playing table and communicatively coupled to an electronic display positioned above the card playing surface. Next, wagers are placed, hole and community cards are dealt to any players participating in the player-banked poker game. After dealing the community cards, a timer is initiated, whereby any player desiring to play will be required to modulate one of the plurality of buttons to cause a visual depiction on the electronic display of the same. Then, for those players who have modulated the button, their cards are compared to determined who wins according to a preset poker hand hierarchy.

### FIELD OF THE INVENTION

The present invention relates generally to gaming systems, tables, and methods, and, more particularly, relates to a player-banked poker gaming utilizing a specialized table and method of use.

### BACKGROUND OF THE INVENTION

Gaming users and gaming operators are continually searching for fun, versatile, and profitable gaming methods and systems, particularly as it relates to the game widely known as “poker.” Those known poker methods and systems, while used by many, fail to provide a user a high level of excitement and provide a profit for operators.

Therefore, a need exists to overcome the problems with the prior art as discussed above.

### SUMMARY OF THE INVENTION

The invention provides a method, system, and table for conducting a player-banked poker game that overcomes the hereinafore-mentioned disadvantages of the heretofore-known devices and methods of this general type and that provides users a high level of excitement for users and profitability for operators.

With the foregoing and other objects in view, there is provided, in accordance with the invention, a [claim 1]

In accordance with another feature, an embodiment of the present invention includes an exciting player-banked poker game method used in connection with an electronic or electromechanical input device, such as a discrete button or switch, used by one or more players to indicate whether they are “in” or “out” in regards to their eligibility to win the wager pot.

Although the invention is illustrated and described herein as embodied in a method, system, and table for conducting a player-banked poker game, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper”, “lower”, “left,” “rear,” “right,” “front,” “vertical,” “horizontal,” and derivatives thereof relate to the invention as oriented in the figures and is not to be construed as limiting any feature to be a particular orientation, as said orientation may be changed based on the user’s perspective of the device. Furthermore, there is no intention to be bound by any expressed or implied theory presented in the preceding technical field, background, brief summary or the following detailed description.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the poker table, from one side to another side. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a perspective downward-looking view, along with a close-up view, of a table for conducting a player-banked poker game in accordance with one embodiment of the present invention;

FIG. 2 is a perspective upward-looking view of the table in FIG. 1;

FIG. 3 is a bottom plan view of the table in FIG. 1;

FIG. 4 is a top plan view of a table for conducting a player-banked poker game in accordance with one embodiment of the present invention;

FIG. 5 is a user interface of a computing device of a user, depicting a table for conducting a player-banked poker game in accordance with one embodiment of the present invention; and

FIG. 6 is a schematic diagram of a system for conducting a player-banked poker game in accordance with one embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

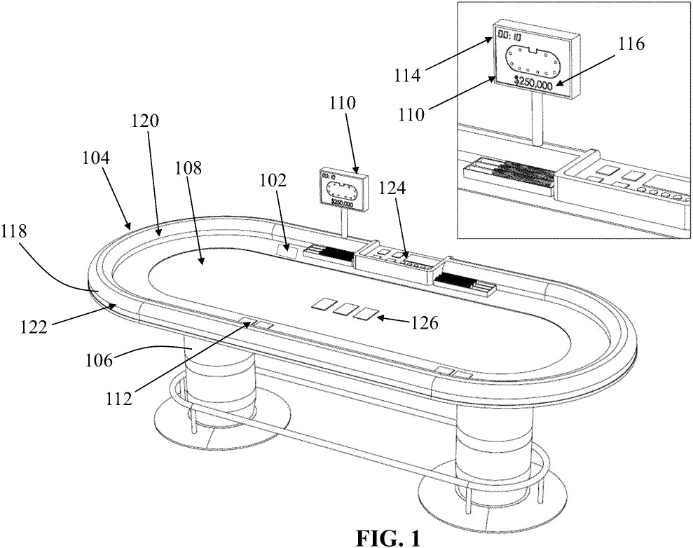

The present invention provides a novel and efficient method for conducting a player-banked poker game. Referring now to FIGS. 1-2 and FIG. 6, one embodiment of the present invention is shown in various views. The figures show several advantageous features of the present invention, but, as will be described below, the invention can be provided in several shapes, sizes, combinations of features and components, and varying numbers and functions of the components. In general, the present invention provides a method, systems and table used to conduct an electronic player-banked poker game that overcomes the disadvantages of the heretofore-known methods and devices of this general type. The invention describes a player-banked poker game wherein, upon the happening of an event triggered through the players’ decision to be “in” or “out” of the hand, e.g., by a player pressing of an electronic button indicating players’ confidential decision to be “in” or “out” (or eligible or not eligible) to win the pot, and if that player has the highest-ranking poker hand, that player is awarded the pot. If the player does not have the highest hand, then losing player(s) must pay or match the pot.

As used herein, the term “player-banked” is defined as a game with players wagering against each other, as opposed to betting against the casino or the house. The term “hole cards” refer to cards dealt to each individual player, belong solely to the player, which are typically unique to each respective player, and remain hidden from other players. The term “community cards” refer to cards typically dealt to the center of the table face-up and shared by all players and/or dealer. The term “wager pot” or “pot” is the sum of money that players wager during a poker hand or game. The term “match the pot” is defined as the losing player(s) paying to the pot an amount equal to that pot or for higher or lesser predetermined amount. The term “chips at risk” refer to minimum amount of player chips available, that can potentially be lost, before each round of play begins. This feature ensures players will have enough money to match the pot if they lose. It should be understood that terms such as, “front,” “rear,” “side,” top,” “bottom,” and the like are indicated from the reference point of a viewer viewing the table 104. Also, the term “wall” is intended broadly to encompass continuous structures, as well as, separate structures that are coupled together so as to form a substantially continuous external surface.

As seen in the figures, the method may first include providing at least one deck of randomly ordered playing cards 102 having four suits each with varying hierarchal ranks. In computer-implemented versions of the present invention, the cards will be digital versions of physical playing cards, randomly ordered using a random number generator. Next and advantageously, the present invention also includes providing a card playing table 104 with one or more leg(s) (an exemplary leg is depicted in FIG. 1 with numeral 106) having a support surface 200, i.e., a surface to support the table on a ground surface such as a casino floor. The playing table 104 also includes a card playing surface 108 positioned above the support surface 200. The card playing surface 108 may be substantially planar in some embodiments. The playing table 104 also beneficially includes a plurality of buttons 202a-n electrically coupled to a power source 600 and positioned around the card playing table 104 and communicatively coupled to an electronic display 110 positioned above the card playing surface 108 and/or the administrator control panel 124 and other electronic devices coupled to the table.

In one embodiment, as shown in FIG. 4 with reference to FIG. 2, a plurality of player position designations 400a-n disposed on the card playing surface 108 may be utilized and positioned around the card playing table. These plurality of player position designations 400a-n may be of varying shapes and sizes, may be of varying depth and color, and/or may have other means to demarcate where a user is to be positioned on the table. In some embodiments, the plurality of player position designations 400a-n are equally spaced around the table. The plurality of buttons 202a-n may correspond in position to the position of the plurality of player position designations 400a-n. In one embodiment, the visual depiction on the plurality of player position designations 400a-n is visually associated on the electronic display 110 with the at least one of the plurality of players participating in the player-banked poker game that activated or failed to activate the at least one of the plurality of buttons 202an. Said differently, if no one activated, the electronic display would show results that no player activated any of the buttons 202a-n.

In one embodiment, the table 104 includes a sidewall 118 at least partially surrounding the card playing surface 108, has an inner sidewall surface 120, and has an outer sidewall surface 122 opposing the inner sidewall surface 118. The sidewall may be padded in some embodiments. The table 104 also includes bottom surface 204 opposing the card playing surface 108, wherein the plurality of buttons 202a-n are positioned on either the outer sidewall surface 122 or the bottom surface 204 of the card playing surface 108. In one embodiment, the plurality of buttons 202a-n are corresponding in position to a plurality of player position designations 400a-n disposed on the card playing table 104. In one embodiment, the card playing table 104 also includes the plurality of player position designations 400a-n are disposed on the card playing surface 108 and positioned around the card playing table.

Employing the specialized table described herein and depicted in the figures, the process may include receiving a wager from a plurality of players participating in a player-banked poker game to have a wager pot. Next, the process may include dealing at least two hole cards 112 from the at least one deck of randomly ordered playing cards 102 to the plurality of players participating in the player-banked poker game. Thereafter, at least three community cards 126 will be dealt from the at least one deck of randomly ordered playing cards 102 on the card playing surface 108 that are to be shared by all of the plurality of players participating in the player-banked poker game.

After dealing the hole cards 112 and, when applicable, after dealing the least three community cards 126, a timer 114 is initiated that is visually depicted on the electronic display 110. The timer 114 has a predetermined timing event caused by the passage of a period of time and may advance in time or countdown in time. Within the period of time, at least one of the plurality of buttons 202a-n are operably configured to be modulated by at least one of the plurality of players participating in the player-banked poker game, and, to cause a visual depiction on the electronic display 110 of the modulation results of the at least one of the plurality of buttons 202a-n. Thereafter and for the plurality of players participating in the player-banked poker game who modulated the at least one of the plurality of buttons 202a-n within the period of time, the at least two hole cards 112 and, when applicable the at least three community cards 126 will be compared with other players participating to ascertain a winning player card hand for a winning player of the plurality of players participating in the player-banked poker game based on a preset poker hand hierarchy. The winning player card hand entitles the winning player to at least a portion of the wager pot. In some embodiments, the losing player(s) if any, would then have to match the pot to fund the next round of play. More specifically, after the timer expires, the process would include comparing the at least two hole cards (and potentially the community cards if played with community cards) to others playing in the game to ascertain a losing player card hand for at least one losing player of the plurality of players participating in the player-banked poker game based on a preset poker hand hierarchy, wherein the losing player card hand requires the at least one losing player to wager in a next player-banked poker game at least a portion of the wager pot. In some embodiments, losing player(s) would be required to match the pot, an amount equal to the wager pot or the preset maximum chips at risk, whichever is less. In preferred versions of the present invention, the visual depiction on the electronic display 110 of the activation of the at least one of the plurality of buttons 202a-n occurs at the predetermined timing event, e.g., when the timer reaches zero.

In one version of the present invention, at least two hole cards from the at least one deck will be dealt to a dealer participating in the player-banked poker game. Further, the method may also include deducting, by a game administrator, at least one of a percentage or a flat fee amount from the wager pot as a rake or commission. The method may also include at least one of a percentage or a flat fee amount deducted from the wager pot that at least partially funds a progressive jackpot 116 visually depicted on the electronic display 110.

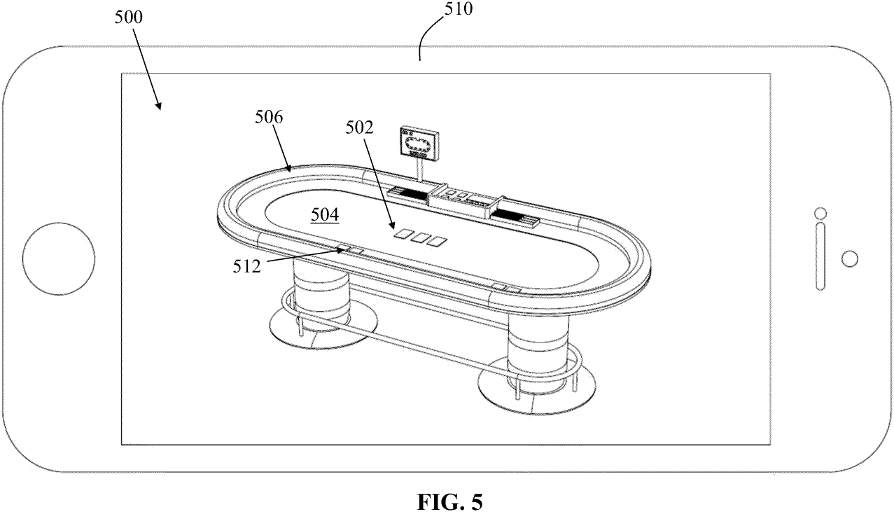

With reference to FIG. 5, a computer-implemented method of providing a player-banked poker game on a computer user interface 500 depicting a specialized table is also within the scope of the present invention. This invention may include providing a non-transitory memory resident on a computing device having a processor and operably coupled to an electronic user interface. The processor is operably configured to carry out a gaming method that includes receiving a wager from a plurality of players participating in a player-banked poker game to have a wager pot, wherein the plurality of players communicatively coupled together over a network, e.g., a WAN network or over the Internet.

Also with reference to FIG. 1 and FIG. 5, the computer-implemented method may include dealing at least two hole cards 512 from at least one deck of randomly ordered digital playing cards having four suits each with varying hierarchal ranks and to the plurality of players participating in the player-banked poker game. Next, the computer-implemented method may include dealing at least three community cards 502 from the at least one deck of randomly ordered digital playing cards on a digital card playing surface 504 of a digital playing card table 506 depicted on the electronic user interface 500 (of a computing device 510, e.g., a cellphone) of each of the plurality of players participating in a player-banked poker game and that are shared by all of the plurality of players participating in the player-banked poker game. After dealing the least three community cards 126, a timer 114 is initiated and visually depicted on the electronic user interface (e.g., interface 500) of each of the plurality of players participating in the player-banked poker game. The timer 114 having a predetermined timing event caused by the passage of a period of time.

Next, the computer-implemented method may include modulating, within the period of time, an electronic button by at least one of the plurality of players participating in the player-banked poker game, and, to cause a visual depiction on the electronic user interface, of each of the plurality of players participating in the player-banked poker game of the modulation of the electronic button. Said another way, after the period of time expires, the electronic display 110 visually depicts, simultaneously, all players’ status of being “in” or “out” of the game, e.g., a player’s decision may be visually depicted with green light for being “in” and a red light for being “out.” Then, the computer-implemented method may include comparing, for the plurality of players participating in the player-banked poker game who modulated the electronic button within the period of time, the at least two hole cards 512 and the at least three community cards 502 to ascertain a winning player card hand for a winning player of the plurality of players participating in the player-banked poker game based on a preset poker hand hierarchy, wherein the winning player card hand entitling the winning player to all or at least a portion of the wager pot.

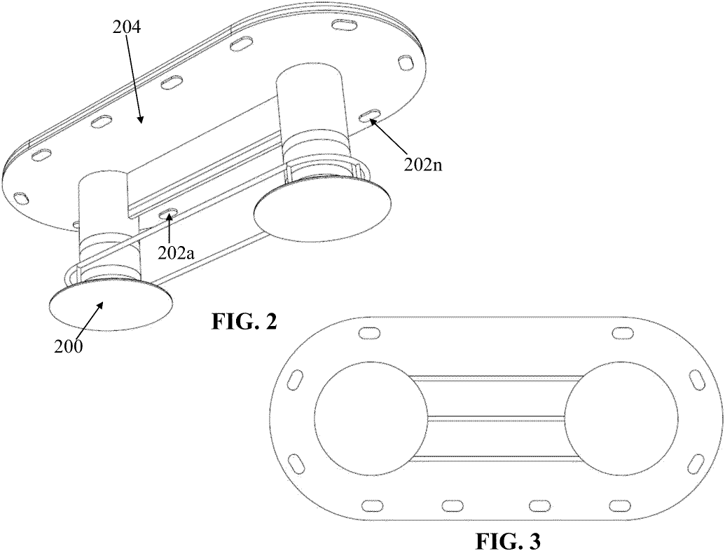

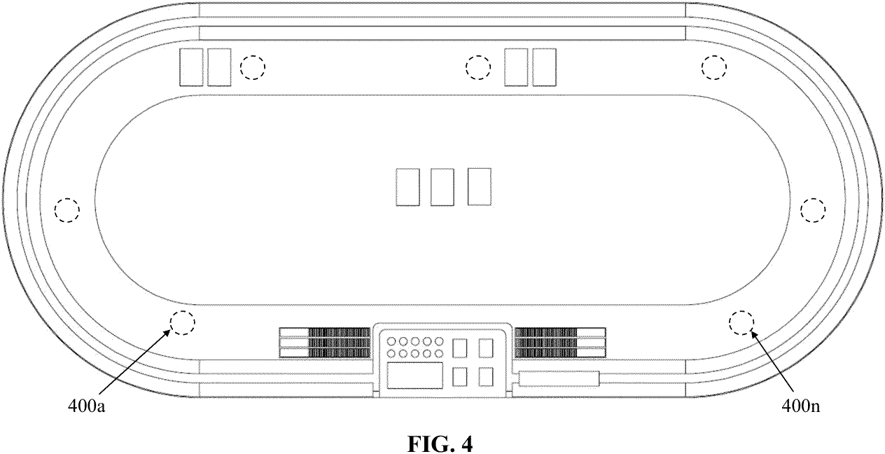

In one embodiment of the present invention the physical poker table 104 is disposed inside a casino, cardroom, live studio, or any other place with various player seats which are used to carry out the described invention. With reference again to FIGS. 1-3 and FIG. 6, the input device may consist of electronically activated or mechanically activated devices 202a-n having an input that may be depressed or activated by each participating player in a confidential or discrete manner, so as to not disclose to any other players at the table of said player’s decision to be “in” or “out,” i.e., whether or not said user wants to participate in the poker hand. In another embodiment of the invention whereas the game is being played online, player would simply elect to be “in” or “out” by clicking or tapping button, or indicating by voice to be “in”. The input device itself, or another device, may not reveal a player’s status of “in” or “out” until all players have made their respective decisions or at the expiration of the countdown, whichever may come first. The “reveal” may be through, for example, an electronic display and/or audio-visual device, e.g., speaker/LED(s), associated with each individual input device or another device in close-proximity (e.g., attached to the table or in same room) as the table in which the player-banked game is being played. The electronic display 110 may include a timer or countdown as the player decisions may then be revealed simultaneously by the display and/or audio-visual device after countdown expires, or sequentially based on the timing of the user’s decision to participate, and/or in a random order of player seats.

After all players’ decision to participate in the player-banked poker game is revealed, the hole cards (e.g., two hole cards 112) for each respective player participating in the game is disclosed to other players and dealer, and compared in terms of their value on a traditional poker hand hierarchy. The players’ decision to be “in” or “out” of the player-banked poker game is generally based on each respective player’s belief that his or her hand is higher, using a poker hand hierarchy, than any other players who may elect to be “in” or participate in the hand.

In one exemplary described process, at least two players at the poker table begin by placing a primary wager or ante that may be required to participate in the player-banked poker game. Preferably, a gaming table, or computerized simulation thereof, will have various portions demarcated for the placement of the ante bet, either physically or electronically, such as via a player user-interface. In some instances, depending on the number of players at the table and house rules, at least one player may participate in the poker game without placing a primary wager or ante, qualifying that player to participate in the poker game (e.g., if any player lost previous hand and had to pay the pot, a new ante may not be necessary for all players).

Next, the administrator or dealer may then deal each player two or more hole cards 112. The hole cards 112 may be dealt face down and therefore in many instances remain confidential. This can be best seen in FIG. 1, wherein a plurality of players each dealt, for example, two hole cards each having a respective value, e.g., ace of clubs, king of clubs. In one other embodiment, players may use a combination of hole cards and community cards to make a poker hand, e.g., two hole cards and at least three and up to five community cards to make the best five card poker hand. In some embodiments of the present invention when only hole cards 112 are dealt, the players will use their hole cards 112 to determine who is a winner in the game. Additionally, similar versions of the game may include a round of discard and draw where players may discard and draw at least one hole card before or after electing to be “in or out”. In other embodiments, a fourth community card would be dealt after the player(s) election to be “in” or “out” making the best five out of six card poker hand. Each player will decide to be “in” or “out” primarily based on the perceived strength of their hand relative to a poker hand hierarchy, e.g., pair, three-of-a-kind, flush, etc. Said another way, if a player believes his or her hole cards are of the highest value of those other players who may elect to be “in,” then generally a user will indicate that they do wish to participate in the poker hand by discretely triggering the input device. The major decision to be “in” or “out” comes with consequence, e.g., as if player “in” and does not have the highest hand, he or she will be required to match the pot and/or provide funds to the pot. In some embodiments, a dealer hand will also be dealt, and players must have a hand higher than the dealer as well as the highest players hand in order to win all or a portion of the pot.

In one embodiment, after each player has had adequate time to review their cards, each player will select or indicate whether to be “in” or “out” of the player-banked poker game that generates a winning result dictated by a high-hand in a poker hand hierarchy. A player’s participation in the poker game may be indicated, in one embodiment, by pressing a button 202a-n on an electronic device, e.g., device, associated with each user at the table 104. The buttons 202a-n may include a shield or cover to inhibit other players at table from viewing, whether a player depressed the button or not, i.e., thereby making the selection confidential or discrete. In some embodiments, the device that must be triggered to indicate decision to be “in” would display on electronic display device.

The electronic display 110 may be used to indicate the players’ decisions and may also include a timer or countdown that would start after the last card is dealt to each individual user or the last user in sequence, giving the players an adequate amount of time to decide whether they are going to be eligible or ineligible to win the pot, in addition would also keep the game moving at a fast pace (which increases the amount of hands per hour—an attribute important to casino profitability). The display device 110 may also indicate which players are participating in the poker hand and which players are not participating in the poker hand, e.g., show the words “in” or “play”, or show a green light could be used to indicate eligible to win status, and decision to not be eligible to win the pot would be indicated by “out” or “fold,” or a red light. This “reveal” of all players election to be “in” or “out” will be displayed simultaneously on the electronic display 110 after the time limit has expired, or after all players have decided, whichever may come first. The display device 110 may be communicatively coupled (as discussed below) to a dealer input panel 124 or other input device, whereby the dealer input 124 may control the activation and/or cessation of the timer and/or other features associated with the game, including timer reset in case of malfunction, making overrides, etc.

In some embodiments, the button(s) 202a-n (wherein “n” represents any number greater than one) may be located on top or underneath the table and pressed by a player’s hand(s) or feet, in a manner to not reveal to other players their confidential decision. In other embodiments, when the electronic device is inoperable or unavailable at the location of the game , the player may still elect to be “in” or “out” by dropping specially designed indicia, e.g., a small poker chip or another small object that can be concealed inside a player’s fist and/or be activated based on user’s decision to participate in the poker hand. The chip or object may have the respective seat number printed on it to indicate which player’s chip it is. In said embodiment, the “reveal” process would include all players, preferably simultaneously, dropping the object that may or may not be in their hand and revealing their decision to be “in” or “out” of the poker hand. In other embodiments, whereas the player-banked poker game is being played online via mobile device player will simply tap button on screen to be “in” or “out”.

In one embodiment, a winning result in the player-banked poker game is triggered or dictated by the value of each respective player’s collective and/or individual hole card value in a poker hand hierarchy. As those of skill in the art will appreciate, one exemplary poker hand hierarchy includes a royal flush, straight flush, a three of a kind, a flush, a straight, a pair, and high card. In other embodiments, these hand values may be interchangeable or can be based on highest to lowest numerical value as opposed to poker hand hierarchy. In other embodiments, players may be allowed to discard and draw at least one other card. Furthermore, some embodiments may include use of the “community cards” or the “dealer’s hand” or a combination of hole cards and community cards. The winning player will be awarded the pot and the losing player will match or pay a portion of the pot which essentially funds the next round of play. Additionally, the casino will collect a predetermined percentage of each pot or a predetermined minimum and maximum amount of currency of each pot as a fee to host the player-banked poker game e.g. “rake”. In other embodiments, a house-banked embodiment the casino may also earn a profit or theoretical house advantage when the dealer hand beats all player hands the casino would win the pot as opposed to raking each pot in the player-banked version.

When the present invention is carried out by a computer processing system, the data processing system may be a symmetric multiprocessor (SMP) system including a plurality of processors connected to system bus. Alternatively, a single processor system may be employed. Also, connected to system bus is memory controller/cache, which provides an interface to local memory. An I/O bus bridge is connected to system bus and provides an interface to I/O bus. The memory controller/cache and I/O bus bridge may be integrated as depicted. The processor in conjunction with memory controller controls what data is stored in memory. The processor and memory controller can serve as a data counter for counting the rate of data flow to the memory or from the memory and can also count the total volume of data accessed to or from the memory, which is non-transitory. The processor can also work in conjunction with any other memory device or storage location. A peripheral component interconnect (PCI) bus bridge may also be connected to I/O bus provides an interface to PCI local bus.

A number of modems, or wireless cards, may be connected to PCI bus. Typical PCI bus implementations will support four PCI expansion slots or add-in connectors. PCI includes, but is not necessarily limited to, PCI-X and PCI Express components.

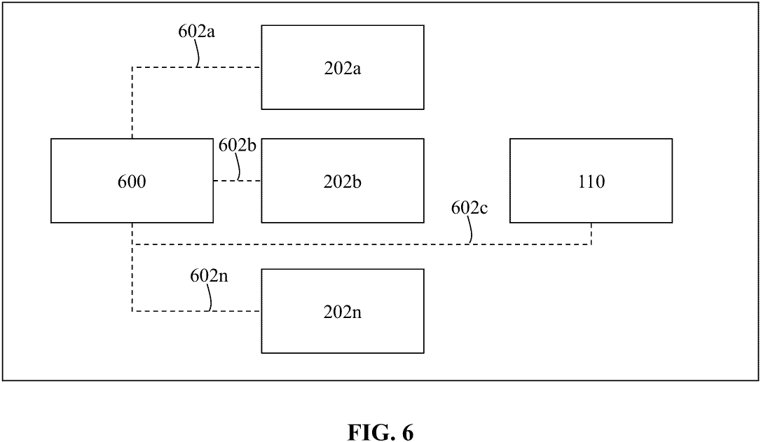

As visually represented in FIG. 6, electrical and/or communications links 602a-n to power source(s) and/or a network as described herein can be seen. For example, a casino server, which may be resident in the United States or abroad, and the plurality of input devices may include connections, which are the medium used to provide communications links between various devices and computers connected together within the system or network. The connections may be wired or wireless connections. A few exemplary wired connections are cable, phone line, and fiber optic. Exemplary wireless connections include radio frequency (RF) and infrared radiation (IR) transmission. Many other wired and wireless connections are known in the art and can be used with the present invention.

In the depicted example, the network can include the Internet, which represents a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, the network also may be implemented as a number of different types of networks, such as for example, an Intranet, a local area network (LAN), or a wide area network (WAN). The system described herein and/or the network may include additional servers and other devices and entities not shown.

Computer programs (also called computer control logic) are stored in memory such as main memory, removable storage drive, removable media, hard disk, and signals. Such computer programs, when executed, enable the computer system to perform the features of the present invention as discussed herein. In particular, the computer programs, when executed, cause the processor and/or to perform the features of the simultaneous website and mobile app creation system. In certain embodiments, the computer program may carry out the timing and “reveal” portions of the above-described method.

In one embodiment, the system permits the plurality of input devices to communicate with a server and/or a display, as described herein. Embodiments of the system are configured such that the server may monitor the input of the plurality of input devices, provide the timing in which a player has to decide to participate in the poker hand and/or notify players of the time deadline to make such a decision and/or convey who is participating in said player-banked poker game.

The device utilized to cause the electronic display 110 to display the player’s indication to play may include a user-input interface, a transceiver to communicate with other components at the table, and/or be electro-mechanical. A user interface as described herein functions to provide a user a method of providing input to the input device of the player’s selection. In other embodiments, the input device may be mechanically activated and/or electro-manically activated. In preferred embodiments, the input device will only have a single input, thereby facilitating in quick and easy understanding of how the user is to input their selection. The user interface may also be a keypad providing a variety of user input operations. The user interface may include keys, buttons, and/or keypads that may be implemented as a touchscreen associated with the input device or display associated with each particular input device. The touchscreen may also provide output or feedback to the user, such as haptic feedback or orientation adjustments of the keypad according to sensor signals received by motion detectors, such as an accelerometer, located within the device.

The network interfaces of the devices may include one or more network interface cards (NIC) or a network controller. In some embodiments, the network interface may include a personal area network (PAN) interface. The PAN interface may provide the capability for the input devices to network using a short-range communication protocol, for example, a Bluetooth communication protocol. The PAN interface may permit the input devices to connect wirelessly to another electronic device via a peer-to-peer connection. The network interfaces may also include a local area network (LAN) interface. The LAN interface may be, for example, an interface to a wireless LAN, such as a Wi-Fi network. In one embodiment, there is a wireless LAN that provides the input devices with access to the Internet for receiving and sending inputs/messages to the server, over the Internet. The range of the LAN interface may generally exceed the range available via the PAN interface. Typically, a connection between two electronic devices via the LAN interface may involve communication through a network router or other intermediary device. Additionally, the network interfaces may include the capability to connect to a wide area network (WAN) via a WAN interface. The WAN interface may permit a connection to a cellular mobile communications network. The WAN interface may include communications circuitry, such as an antenna coupled to a radio circuit having a transceiver for transmitting and receiving radio signals via the antenna. The radio circuit may be configured to operate in a mobile communications network, including but not limited to global systems for mobile communications (GSM), code division multiple access (CDMA), wideband CDMA (WCDMA), and the like.

Memory associated with the input devices may be, for example, one or more buffer, a flash memory, or non-volatile memory, such as random-access memory (RAM). The input devices may also include non-volatile storage. The non-volatile storage may represent any suitable storage medium, such as a hard disk drive or non-volatile memory, such as flash memory. The processing device can be, for example, a central processing unit (CPU), a microcontroller, or a micro processing device, including a “general purpose” micro processing device or a special purpose micro processing device. The processing device executes code stored in memory in order to carry out operation/instructions of the input devices, e.g., to display or communicate the player’s selection in the poker game after receiving the player’s input of the same. The processing device may provide the processing capability to execute an operating system, run various applications, such as the website/app editing application interface, communicate with one or more microcontrollers, and provide processing for one or more of the techniques and process steps described herein.

The display 110 displays information to the user such as the player’s selection/decision (as described above), a timer, progressive jackpot, table limits, game rules, and the like. The display may be used to present various images, text, graphics, or videos to the user. The display may be any type of suitable display, such as a liquid- crystal display (LCD), a plasma display, a light-emitting diode (LED) display, or the like. The input devices may include audio input and output structures, such as a microphone for receiving audio signals from a user, e.g., of their selection, and/or a speaker for outputting audio data, such as audio-visual alerts of the player’s selection and/or of the timing deadline to make said selection received by the input devices over a network, and the like.

In some commercial embodiments, the game administrator or the casino is compensated by taking a percentage of each pot as revenue. In one embodiment, the house may take 5% of each pot as revenue for conducting the game. In other embodiments, the house may take a higher or lower percentage, flat fee, or minimum and maximum amount depending on house rules and jurisdiction. Other embodiments, or non-commission variants of the game method, the house would not take a rake but would take all the losing bets if the dealer hand is a certain preset poker hand or a hand higher than at least one other player hands (e.g., house automatically wins the pot when dealer has any straight flush and beats all other player hands). This slight variation will create a mathematical advantage for the house by winning a pot with a straight flush and never being required to place a bet. This method may be combined with a rake or used instead of a rake., whichever is preferred by the house.

In further embodiments of the invention, players may be eligible for the amount of the current progressive jackpot. In this manner, if any or all players do not win, i.e., the preset card value is not met, a portion of the bet money is allocated to the next round, where one or more players will be eligible to win in total or in part of the combined accumulated bets. In some embodiments, the “dealer” and the “house” will proportionately share the benefit of players’ losing wagers. In addition, the dealer or dealers may receive a portion of the payout resulting from a winning combination of player or dealer cards. This feature will advantageously keep dealers motivated to promote and deal the game.

In the above-described game of poker, some level of skill is combined with the receiving of the playing cards that is based solely on chance, a combination many users and administrators of the described invention will find desirable. The method and device described combines a poker game requiring at least one player decision, to be “in” or “out”. In addition, some embodiments include a player’s option to discard and draw cards or another round of betting where players can either bet or fold, which create an additional layer of skill and decision making.

The described invention may also include certain side bets that may be made in addition to, or in connection to the base game wager. For example, a player may make a secondary bet or house-banked side bet whereas the player would play against a house-banked pay table using the same hole cards and/or community cards dealt in the base game. For example, if a player was dealt a straight flush and was eligible for the base game and the side game they may win the main pot (which is player-banked) and also win 30 to 1 for their straight flush hand in the side game according to the house-banked pay table associated with the side game. The side game is an optional wager and is not required to participate in the base game. The side game may be player-banked or house-banked and may use either player hole cards, community cards, or a combination of both. In another exemplary embodiment, the side game would be won when the dealer hand contains a pair or better and players would win certain odds according to the pay table.

The base game and side game can be played as live table game in a gaming establishment, e.g., a casino, a virtual table game in a gaming establishment or online over a network (e.g., using the Internet), or an electronic/slot machine style game in a gaming establishment. Moreover, the present invention can also be carried out online over network or offline using a desktop computer, mobile device, tablet, a smartphone, or any other electronic processing device with or without wireless or LAN capabilities.

The steps of the present invention, which are explained in more detail above, can be embodied in a computer program that is executable by one of the above-described processors, that may be on (e.g., communicatively coupled to) a video gaming machine. Computer programs (also called computer control logic) are stored in memory such as main memory, removable storage drive, removable media, hard disk, and signals. Such computer programs, when executed, enable the computer system to perform the features of the present invention as discussed herein. In particular, the computer programs, when executed, enable the processor to perform the steps of the present invention.

As such, the video gaming machine implemented with carrying out the above-described steps may include a computing means, e.g., a processor, and a storing means, e.g., a memory. The processor is operable to run one or more programs/applications and interfaces associated with the video gaming machine or stored on the memory in order to effectuate the data transfer and communications required by the present invention. The video gaming machine may also have other components or features that may include an image capturing element, lights, multiple displays, or other transducers.

In one software embodiment, the program may be designed to API interface or be added onto an existing online poker platform. This advantageous embodiment will allow for easier installation across multiple different platforms such as different online casinos that offer real money poker games and free to play or social poker games. In one hardware embodiment, the electronic input device may be a button or switch underneath the existing poker table or the input device may be activated by pressing a touch screen LCD device indicating in or out status of player.

Although a specific order of executing the process steps, the order of executing the steps may be changed relative to the order shown in certain embodiments. Also, two or more steps described as occurring in succession may be executed concurrently or with partial concurrence in some embodiments. Certain steps may also be omitted for the sake of brevity. In some embodiments, some or all of the process steps can be combined into a single process.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above described features.

What is claimed is:

1. A computer-implemented user identity verification method comprising:
providing a user electronic computing device of a verifying user with an electronic display, a memory, a camera, and an executable identity verification software application resident the memory thereon;
providing a requestor electronic computing device of a requesting user;
providing a first administrator server and a second administrator server;
receiving, at the first administrator server that is communicatively coupled to the user electronic computing device over a network, biometric user data of the verifying user from the user electronic computing device, personalized user data from the user electronic computing device, and unique phone data from the user electronic computing device;
compiling the biometric user data, the personalized user data, and the unique phone data into a single user identity data file, encrypting the single user identity data file and generating a data decryption key, and segregating the single user identity data file into a plurality of encrypted segregated user identity data files each independently stored on the first administrator server and the second administrator server;
communicating the data decryption key to the user electronic computing device for storage on the memory thereon; and
communicating an electronic identity verification request to the user electronic computing device, the electronic identity verification request forming a closed-network identity verification session that includes:
executing the identity verification software application on the user electronic computing device;
communicatively coupling the user electronic computing device, the first administrator server, and the second administrator server over the network;
communicating, from the user electronic computing device, at least one of secondary biometric user data of the verifying user, secondary personalized user data, and secondary unique phone data from the user electronic computing device to at least one of the first administrator server and the second administrator server;
communicating the data decryption key from the user electronic computing device to at least one of the first administrator server and the second administrator server;
aggregating the plurality of encrypted segregated user identity data files stored on the first administrator server and the second administrator server to generate and decrypt, utilizing the data decryption key, the single user identity data file;
autonomously verifying an identity of the verifying user by comparing the at least one of the secondary biometric user data of the verifying user, the secondary personalized user data, and the secondary unique phone data from the user electronic computing device to at least one of the biometric user data of the verifying user from the user electronic computing device, the personalized user data from the user electronic computing device, and the unique phone data from the user electronic computing device to ascertain a data and identity match; and
communicating an indication of the data and identity match to the requestor electronic computing device without the copying and storage of the personalized user data on the requestor electronic computing device.

2. The computer-implemented user identity verification method according to claim 1, wherein the biometric user data of the verifying user received from the user electronic computing device includes a digital facial image depicting the verifying user taken by the camera of the user electronic computing device, the closed-network identity verification session further comprising:
taking a picture of the verifying user from the camera of the user electronic computing device, the picture of the verifying user from the camera of the user electronic computer device forming part of the secondary biometric user data of the verifying user and communicating the at least one of a secondary biometric user data of the verifying user to the at least one of the first administrator server and the second administrator server; and
autonomously verifying an identity of the verifying user by comparing the picture of the verifying user from the camera of the user electronic computer device forming part of the secondary biometric user data of the verifying user to the digital facial image depicting the verifying user taken by the camera of the user electronic computing device to ascertain the data and identity match.

3. The computer-implemented user identity verification method according to claim 2, further comprising:
communicating the electronic identity verification request to the user electronic computing device using a SMS text.

4. The computer-implemented user identity verification method according to claim 2, further comprising:
storing the at least one of the secondary biometric user data of the verifying user, the secondary personalized user data, the secondary unique phone data from the user electronic computing device, the at least one of the biometric user data of the verifying user from the user electronic computing device, the personalized user data from the user electronic computing device, and the unique phone data from the user electronic computing device used in the closed-network identity verification session on at least one of the first administrator server and the second administrator server on a data block forming part of an interconnected plurality of data blocks linked together and each also having a cryptographic hash of a previously generated block and a timestamp.

5. The computer-implemented user identity verification method according to claim 2, wherein the user electronic computing device and the requestor electronic computing device are located in geographically remote and independent locations with respect to the first administrator server and the second administrator server.

6. The computer-implemented user identity verification method according to claim 2, further comprising:
segregating the single user identity data file into the plurality of encrypted segregated user identity data files each of randomly generated data sizes.

7. The computer-implemented user identity verification method according to claim 2, further comprising:
communicating, from the requestor electronic computing device communicatively coupled to the user electronic computing device, the electronic identity verification request to the user electronic computing device.

8. The computer-implemented user identity verification method according to claim 2, wherein the closed-network identity verification session further comprises:
communicatively coupling the user electronic computing device, the first administrator server, the second administrator server, and the requestor electronic computing device together on the network.

9. The computer-implemented user identity verification method according to claim 2, further comprising:
providing the first administrator server, the second administrator server, and a third administrator server, wherein the data decryption key is backed-up on the third administrator server.

10. The computer-implemented user identity verification method according to claim 2, wherein:
the biometric user data including the digital facial image depicting the verifying user taken from a physical indicia of identification depicting a facial image depicting the verifying user, the physical indicia of identification including at least one of a government issued license and a government issued passport.

11. The computer-implemented user identity verification method according to claim 10, further comprising:
a digital geolocation associated with metadata from the facial image of the verifying user taken by the camera of the electronic computing device, a physical card image depicting a facial image of the verifying user, and a digital phone verification from the electronic computing device sent by the first server.

12. The computer-implemented user identity verification method according to claim 2, further comprising:
receiving, at the first administrator server that is communicatively coupled to the user electronic computing device over a network, asset data of the verifying user from the user electronic computing device;
compiling the asset data into a single asset identity data file, associating the single asset identity data file with the verifying user, encrypting the single asset identity data file and generating a data decryption key, and segregating the single asset identity data file into a plurality of encrypted segregated asset identity data files each independently stored on the first administrator server and the second administrator server;
communicating the data decryption key to the user electronic computing device for storage on the memory thereon;
communicating an electronic identity verification request to the user electronic computing device, the electronic identity verification request forming a closed-network identity verification session that includes:
executing the identity verification software application on the user electronic computing device;
communicatively coupling the user electronic computing device, the first administrator server, and the second administrator server over the network;
communicating, from the user electronic computing device, at least one of secondary biometric user data of the verifying user, secondary personalized user data, and secondary unique phone data from the user electronic computing device to at least one of the first administrator server and the second administrator server;
communicating the data decryption key from the user electronic computing device to at least one of the first administrator server and the second administrator server;
aggregating the plurality of encrypted segregated asset identity data files stored on the first administrator server and the second administrator server to generate and decrypt, utilizing the data decryption key, the single asset identity data file;
autonomously verifying an identity of the verifying user by comparing the at least one of the secondary biometric user data of the verifying user, the secondary personalized user data, and the secondary unique phone data from the user electronic computing device to at least one of the biometric user data of the verifying user from the user electronic computing device, the personalized user data from the user electronic computing device, and the unique phone data from the user electronic computing device to ascertain a data and identity match; and
communicating an indication of the asset data and user identity match to the requestor electronic computing device.

13. The computer-implemented user identity verification method according to claim 2, further comprising:
the closed-network identity verification session including, after the data and identity match, recompiling the single user identity data file, encrypting the single user identity data file and generating a secondary data decryption key, and segregating the single user identity data file into a plurality of secondary encrypted segregated user identity data files each independently stored on the first administrator server and the second administrator server; and
communicating the secondary data decryption key to the user electronic computing device for storage on the memory thereon.

14. A computer-implemented user identity verification method comprising:
providing a user electronic computing device of a verifying user with an electronic display, a memory, a camera, and an executable identity verification software application resident the memory thereon;
providing a requestor electronic computing device of a requesting user;
providing a first administrator server and a second administrator server;
receiving, at the first administrator server that is communicatively coupled to the user electronic computing device over a network, biometric user data of the verifying user from the user electronic computing device;
compiling the biometric user data into a single user identity data file, encrypting the single user identity data file and generating a data decryption key, and segregating the single user identity data file into a plurality of encrypted segregated user identity data files each independently stored on the first administrator server and the second administrator server;
communicating the data decryption key to the user electronic computing device for storage on the memory thereon; and
communicating an electronic identity verification request to the user electronic computing device, the electronic identity verification request forming a closed-network identity verification session that includes:
executing the identity verification software application on the user electronic computing device;
communicatively coupling the user electronic computing device, the first administrator server, and the second administrator server over the network;
communicating, from the user electronic computing device, secondary biometric user data of the verifying user from the user electronic computing device to at least one of the first administrator server and the second administrator server;
communicating the data decryption key from the user electronic computing device to at least one of the first administrator server and the second administrator server;
aggregating the plurality of encrypted segregated user identity data files stored on the first administrator server and the second administrator server to generate and decrypt, utilizing the data decryption key, the single user identity data file;
autonomously verifying an identity of the verifying user by comparing the secondary biometric user data of the verifying user from the user electronic computing device to the biometric user data of the verifying user from the user electronic computing device, to ascertain a data and identity match; and
communicating an indication of the data and identity match to the requestor electronic computing device without the copying and storage of the personalized user data on the requestor electronic computing device.
